(19) United States
(12) Patent Application Publication
(10) Pub. No.: US 2014/0283752 A1
(43) Pub. Date: Sep. 25, 2014

(54) PAD FOR WASTE COLLECTION AND DISPOSAL

(71) Applicant: Nuguna Robin Lowe, Bronx, NY (US)

(72) Inventor: Nuguna Robin Lowe, Bronx, NY (US)

(21) Appl. No.: 13/847,991

(22) Filed: Mar. 20, 2013

(51) Int. Cl. A01K 1/01

(52) U.S. Cl. CPC A01K 1/0107
USPC 119/161

(57) ABSTRACT

Waste collection pads are provided which have on their upper surface a waste collection area, the perimeter of the collection area being defined by a self-sealing strip. Suitable self-sealing strips include hook-and-loop, plastic zipper, and adhesive strips. In use, waste is deposited on the waste collection area, and the pad is then folded over so as to functionally engage the self-sealing strips. The waste is thereby contained and substantially sealed off from the environment. An absorbent layer, substantially covering the waste collection area, may optionally be present.

### RELATED APPLICATIONS

There are no related applications or priority claims associated with this filing.

### FIELD OF THE INVENTION

The invention relates to methods and devices for the collection and disposal of waste materials. Certain embodiments are particularly directed to devices for the convenient collection and disposal of bodily waste from pet animals.

### BACKGROUND

A growing number of towns and municipalities, in response to aesthetic and sanitary concerns of the public, have enacted local laws which require the owners of dogs and other animals to pick up and dispose of their pets' feces. These statutes are generally enforced by the imposition of fines on pet owners who fail to comply. As such “pooper scooper” laws have proliferated, a market has developed for devices and methods intended to make the task less unpleasant, and in particular to reduce the potential for contact of the waste material with the user. Inventors have responded by developing and patenting an array of scoopers, disposal bags, pads, diapers, and gloves, and creative combinations thereof.

The mechanical scooping devices tend to be unwieldy, and cleaning them can be even more unpleasant than the task they are intended to simplify. Specialized, disposable gloves and mitts have been designed, but they offer little advantage over the plastic “sandwich” bag that many pet owners have adopted as the most common tool of the trade. While insulating the user from actual contact, the polyethylene film of such bags is usually so thin and pliable that the sensation of handling the droppings is present, to an extent that many users still find objectionable.

All of the above devices share an additional disadvantage, which is that they may leave a residue of fecal matter on the sidewalk or street, if the droppings are not solid enough to be picked up intact. For this reason, devices that prevent the droppings from contacting the ground would be preferable. Diaper-like pads and bags, intended to be attached to the pet and capture waste as it is eliminated, have not proven popular, in all probability due to the fact that such devices are aesthetically unappealing. Many pet owners put a considerable value on appearances, and whatever image they wish to project while walking their animals would not be enhanced by the appearance of a diapered pet.

Pads that are placed underneath the pet at the time the animal is defecating, in contrast, are a simple, unobtrusive, and effective solution to the above problems. Effective placement of the pads is not a problem, as an animal tends not to move once defecation is underway. Nonetheless, most prior art pads are not designed to be carried outdoors, to be deployed when needed, but instead are designed to be put in a fixed location indoors, and used as needed by the animal, e.g as a litter box liner for cats, or a designated pet “waste station” for dogs. One of the earliest of such designs, disclosed in U.S. Pat. No. 4,800,677 (1989), is typical in having an impermeable backing sheet, an absorbent layer disposed thereon, and a permeable topsheet. The pad features a capsule containing a scent, intended to attract the dog to the pad, and adhesive tabs enabling the pad to be fixed to the floor while awaiting use. Tapes or drawstrings are provided for tying the pad and waste into a bundle for disposal.

Improvements to waste collection and disposal pads have featured such improvements as a smooth, non-fibrous topsheet that does not engage the animals' claws (U.S. Pat. No. 8,101,845 (2012)); high-capacity particulate absorbents combined with a particle-trapping topsheet (U.S. Pat. Nos. 7,654,227 (2010), 7,726,260 (2010) and 8,101,532 (2012)); integral tie strips (U.S. Pat. No. 6,976,451 (2005)); and reinforcing strips and attached handles (U.S. Pat. No. 5,178,426 (1993)).

The use of prior art pads still presents some risk of contact with the animal waste, in that most pads must be handled to some extent, by folding and/or taping or tying into a bundle. The resulting bundles are not well-sealed, and are prone to leak if the waste happens to be fluid in nature; the bundles, being poorly sealed, are also prone to the release of odors. This is an unpleasant problem for the user if the bundled waste has to be carried any distance, for example to reach the nearest trash receptacle.

There remains a need for waste collection pads that minimize the risk of contact with the waste, and which more effectively seal and contain the waste and its associated odors.

### BRIEF DESCRIPTION OF THE INVENTION

The present invention provides a waste collection pad comprising a planar non-permeable layer having, on its upper surface, a sealing strip, which defines at least one half of a perimeter that in its entirety encloses a portion of the upper surface. A sealing strip contact area is symmetrically disposed opposite to the sealing strip, and defines the other half of the perimeter. The sealing strip and sealing strip contact area are mutually adherent, and are so disposed that they come into register when the pad is folded along a diagonal. The pad preferably also comprises an absorbent layer disposed on the non-permeable layer. The absorbent layer may be interrupted at the location of the sealing strip, allowing the sealing strip to be directly affixed to the non-permeable layer, or alternatively it may be interposed between the non-permeable layer and the sealing strip.

In preferred embodiments, the pad also comprises a drawstring or tape movably embedded in the periphery, of the pad. The drawstring or tape has one or more exposed sections so situated that the user can draw the pad into a pouch by pulling on the tape or drawstring, and secure it by tying off the withdrawn portion.

In addition to their utility for collecting and disposing of pet waste, the pads of the present invention may be used in a variety of other settings, for example to collect kitchen waste such as trimmings from meat and vegetables, or as a disposable cover for a diaper changing table, or in an artist's studio or mechanic's workshop, for the collection and disposal of paints and oils and the like. The pads are generally suitable for handling sticky, oily, or wet materials that are not amenable to simple sweeping or vacuuming.

The pads of the invention are also expected to find use as lap coverings, to protect a person's clothing when eating without a table, for example in a car or on a park bench. The practice of eating fast food in automobiles has created a particular need for the pads of the invention, in view of the well-known inadequacy of ordinary paper napkins.

### BRIEF DESCRIPTION OF THE FIGURES

FIG. 1 is a perspective view of one embodiment of the invention.

FIG. 2 is a side view of a folded pad of the invention.

FIGS. 3A-3C are plan views showing different geometries of the waste collection area.

### DETAILED DESCRIPTION OF THE INVENTION

The present invention provides a waste collection pad comprising a planar non-permeable sheet having, on its upper surface, a sealing strip, which defines at least one half of a perimeter that encloses a portion of the upper surface. This portion is referred to as the waste collection area, and comprises at least 25% of the area of the pad, preferably at least 50%, and may comprise up to 90% of the area of the pad.

The non-permeable sheet may be formed of any flexible polymer suitable for use in sheet form, such as those commonly used in the manufacture of backing layers for diapers, sanitary pads, and medical dressings. Preferred materials are polyethylene and polypropylene, and blends and co-polymers thereof, which are well-known in the art. The form of the material may be selected on the basis of manufacturing cost and convenience; examples include, without limitation, spun-melt non-woven fabrics and blown films. The sheet material should resist tearing, but preferably can be stretched to a moderate degree.

The area defined by the perimeter is the intended collection area, where the waste to be collected and disposed of is preferably deposited or collected. Upon folding the pad over, along an axis defined by the two ends of the sealing strip, the sealing strip will contact a mirror-image area of the pad's surface, as reflected across the axis of the fold, which is referred to herein as the sealing strip contact area. The sealing strip and the sealing strip contact area effectively define the perimeter of the collection area. The sealing strip and the sealing strip contact area are mutually adherent, i.e., the surface of the sealing strip contact area is configured so as to interact with the sealing strip in a manner that forms a seal; the resulting seal will accordingly enclose the collection area defined by the perimeter, and form a pouch enclosing any waste materials deposited thereon. The seal need not be airtight or watertight, but is preferably so.

The axis of the fold is preferably a line from one corner of the pad to the opposite corner, i.e. a diagonal across the pad. In this embodiment, the user can handle the pad by its corners, which will typically be a greater distance from the deposited waste than are the sides of the pad.

The shape of the collection area may be circular, so that the sealing strip and sealing strip contact area each have the form of a semi-circular arc. The shape may optionally vary from circular, with corresponding alterations in the length and shape of the arcs. In alternative embodiments, the collection area may be, for example, in the shape of a square or rectangle, with the sealing strip and sealing strip contact areas being appropriate linear segments. Other shapes are of course possible, with simple variations in the shape of the sealing strip, and all such shapes are to be regarded as being within the scope of the invention. The sealing strip contact area, if its location is not evident, may be marked by printed indicia, for the convenience of the user, but in most embodiments bringing the edges of the pad into register, upon folding, will bring the sealing strip and sealing strip contact area into appropriate registration as well.

By way of example, the sealing strip may comprise a pressure-sensitive self-adhesive material, and the sealing strip contact area may be the surface of the non-permeable sheet itself. In those embodiments which feature an absorbent layer, as described below, the absorbent layer will preferably be absent where the sealing strip and sealing strip contact area are present, so as to permit the direct contact of the non-permeable sheet with the adhesive. In alternative embodiments, if the absorbent layer has sufficient strength to form a mechanically sound bond with the adhesive, the sealing strip contact area may be a portion of the surface of the absorbent layer, or a portion of the surface of any topsheet that may be present.

Pressure-sensitive self-adhesive materials suitable for use in bonding to non-permeable polymer sheets are well-known in the art, as used for example in self-sealing spunbond polyolefin envelopes, or in the adhesive tabs used in disposable diapers. The adhesive layer typically has a thickness of about 1 to about 5 mils, but can be lesser or greater, depending upon the adhesive employed. Examples of suitable pressure-sensitive adhesives include rubber-type adhesives, acrylic adhesives, vinyl acetate-type adhesives, urethane-type adhesives, styrenic and olefinic adhesives, and combinations thereof. Particularly suitable are electron beam or ultraviolet-curable acrylic, olefinic, and styrenic adhesives.

Rubber-type adhesives include, but are not limited to, adhesives comprising natural rubber, isoprene rubber, styrene-butadiene rubber, styrene-butadiene block copolymer, styrene-isoprene block copolymer, butyl rubber, polyisobutylene, silicone rubber, polyvinyl isobutyl ether, chloroprene rubber, nitrile rubber, and mixtures of the forgoing.

Acrylic adhesives include, but are not limited to, those comprising homopolymers, copolymers, or crosslinked copolymers of at least one acrylic or methacrylic component, for example acrylic esters such as lower alkyl acrylates, octyl acrylate, 2-ethylhexyl acrylate, undecyl acrylate, tridecyl acrylate, or lauryl acrylate; and optional co-monomers. Co-monomers include, but are not limited to, carboxyl-containing monomers such as acrylic acid, methacrylic acid, itaconic acid, crotonic acid, maleic acid, maleic anhydride, or butyl maleate; hydroxyl-containing monomers such as 2-hydroxyethyl(meth)acrylate, 2-hydroxypropyl(meth)acrylate or allyl alcohol; amido-containing monomers such as (meth)acrylamide, N-methyl(meth)acrylamide, or N-ethyl(meth)acrylamide; methylol group-containing monomers such as N-methylol(meth)acrylamide or dimethylol(meth)acrylamide; amino-containing monomers such as aminoethyl(meth)acrylate, dimethylaminoethyl(meth)acrylate, or vinylpyridine; non-functional monomers such as ethylene, propylene, and other alpha-olefins, styrene, or vinyl acetate; and mixtures thereof.

Vinyl acetate-type adhesives include, but are not limited to, those comprising polyvinyl acetate, a copolymer of vinyl acetate with a monomer such as ethylene or vinyl chloride, and mixtures thereof.

Urethane-type adhesives include, but are not limited to, those comprising polymeric compounds formed by the reaction of an isocyanate such as triphenylmethane-p,p′,p″-triisocyanate, hexamethylene diisocyanate, diphenylmethane 4,4′-diisocyanate, or toluenediisocyanate with a compound having an active hydrogen atom such as polyesters having active hydrogen, polyether glycol, polyacrylates, or polyamides, and mixtures thereof.

When the sealing strip comprises an adhesive, it may be desirable or necessary to cover the adhesive with a non-adherent release layer, e.g. a waxed or silicone-treated disposable strip, to prevent undesired adhesion to other parts of the pad, or to other pads, while the pads are packaged for transportation and storage. In a preferred embodiment, when the pads of the invention are folded for storage prior to use, the adhesive layer is in contact with a portion of the non-permeable sheet that is or has been rendered non-adherent. The adhesive may advantageously be chosen on the basis that it can be chemically bonded onto the area of the backing sheet to which it was applied during manufacture, for example by ultraviolet or electron beam cross-linking, yet after manufacture it can be easily peeled away from other areas of the backing layer that it comes into contact with while in storage. Alternatively, or additionally, the portions of the backing layer that come into contact with the adhesive during storage may be rendered less adherent, for example by impressing a smooth, glossy surface, or by providing a thin coating of silicone, fluorocarbon, wax, or other non-adherent material.

In another embodiment, the sealing strip may constitute the hook portion of a hook-and-loop fabric fastener system. Mutually adherent hook-and-loop systems are well known in the art, for example the systems sold under the trade name VELCRO™ by Velcro USA Inc., Manchester N.H. See for example U.S. Pat. No. 3,009,235 (1961 to G. de Mestral), and the numerous patents and applications that cite it. Polymer surfaces may be prepared with integral hooks; see for example U.S. Pat. No. 7,670,522 (2010 to Ausen et al.), and references cited therein. As an alternative to hooks, so-called “mushroom” fasteners may be employed. The sealing strip contact area may be a strip of an appropriate loop fabric designed for the purpose, or alternatively the surface of the pad, absorbent layer, or topsheet may be a woven or non-woven fabric capable of engaging the hooks or mushrooms of the sealing strip. See for example U.S. Pat. No. 6,904,649 (2005 to B. VanBenschoten et al.), and references therein.

In yet another embodiment, the sealing strip may take the form of one component of a plastic zipper strip, and the sealing strip contact area may be a complementary zipper strip, laid out as a mirror image of the sealing strip so as to place the mating zipper strips in direct opposition when the pad is folded. Plastic zipper strips are well-known in the art; see for example U.S. Pat. Nos. 4,212,337, 4,658,433 4,778,282, and 6,088,998, the entire contents of which are incorporated herein by reference. Examples of commercially available plastic zipper strips are those sold under the trade name ZIPLOC™ (S. C. Johnson & Son Inc., Racine Wis.) Most of the known designs are expected to be operable as sealing strips in the present invention, although sliderless designs are much more easily incorporated into the pads of the present invention. The complementary mating strips will preferably be closely aligned at their ends, and optionally will be pre-engaged at one end, to assist the user in initiating the zippering together of the strips.

In a preferred embodiment, the sealing strip and the sealing strip contact area are identical layers of adhesive. In a more preferred embodiment, these strips are linear and are oriented close to and parallel to the edges of the pad. In this context, “close to” means within between 1% and about 300% of the width of the sealing strip. Preferably, the distance is about 200% of the width of the sealing strip.

A waste collection pad, in this embodiment, thus comprises a non-permeable sheet having an adhesive sealing strip disposed on the upper surface thereof, wherein the sealing strip defines the perimeter of the waste collection area.

In certain preferred embodiments, the pad further comprises an absorbent layer disposed on the non-permeable layer. The absorbent layer may be interrupted at the location of the sealing strip, allowing the sealing strip to be directly affixed to the non-permeable layer, or alternatively it may be interposed between the non-permeable layer and the sealing strip. The absorbent layer may be limited to the collection area in certain embodiments; in alternative embodiments at least a portion of the pad outside of the collection area will also feature an absorbent layer, so as to catch and retain any waste that might spill or be deposited outside of the collection area. In addition to serving as an absorbent of fluids, an absorbent layer having some degree of loft will also serve to capture small particles, for example bread crumbs that may fall onto the pad when it is used as a napkin on one's lap. The waste collection pad in this embodiment thus comprises an absorbent layer disposed on the upper surface and substantially covering (covering 80-100% of) the waste collection area. In those embodiments featuring a drawstring, the drawstring will serve as backup means of bundling the pad and containing the waste.

Reference is now made to the drawings, where the elements of the invention and their relationship to one another are illustrated. The drawings present specific embodiments of the invention, which is not limited to the examples selected for illustration in the Figures.

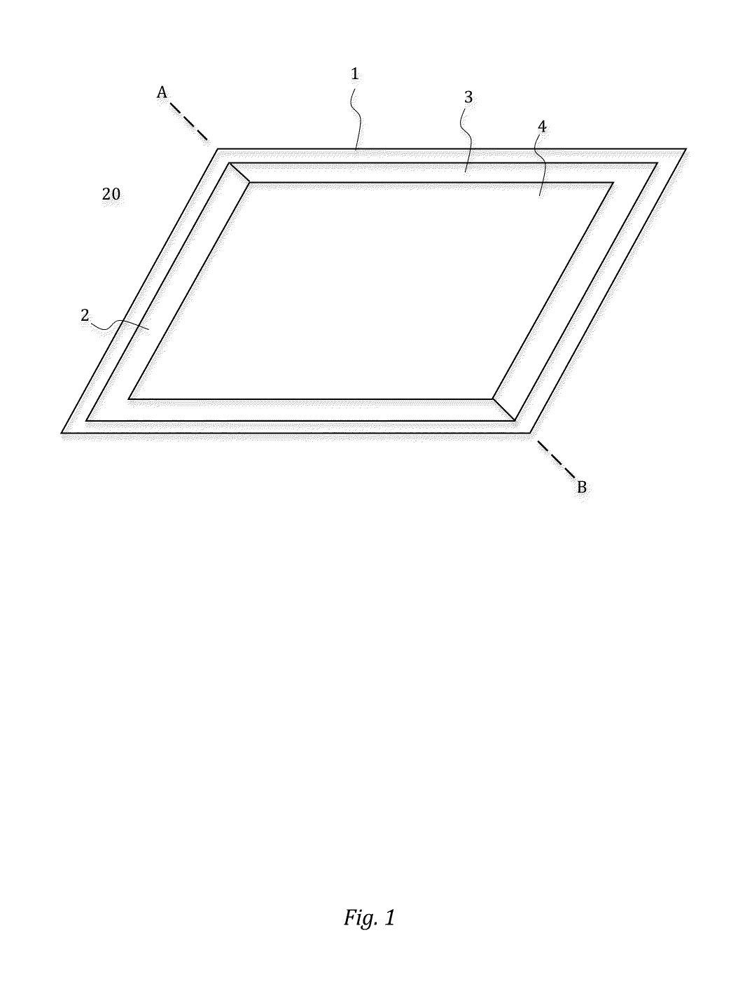

FIG. 1 depicts a perspective view of a waste collection pad of the invention. The pad 20 in this embodiment is substantially square in shape. The pad comprises a non-permeable backing layer 1, a sealing strip 2 disposed on the surface thereof, and a sealing strip contact area 3 symmetrically disposed opposite to the sealing strip. The sealing strip 2 and sealing strip contact area 3 together define the perimeter of the waste collection area 4.

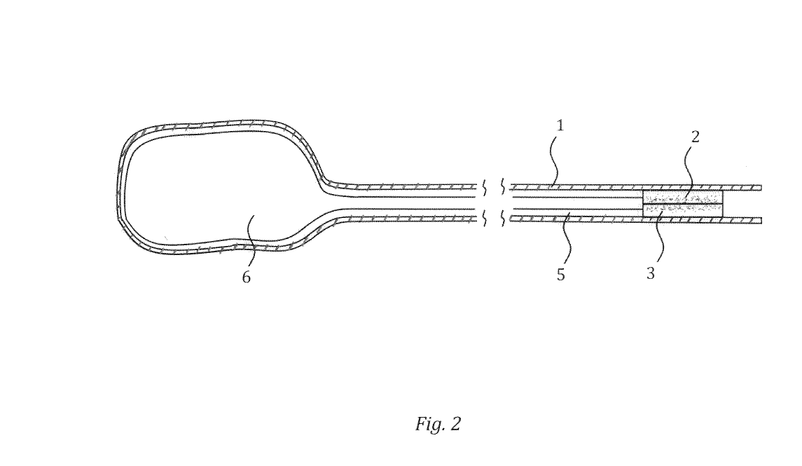

Once waste has been deposited within collection area 4, the pad is folded over by the user, substantially along the diagonal A-B, so as to bring sealing strip 2 and sealing strip contact area 3 into register, as shown in FIG. 2. In the particular embodiment shown in FIG. 2, both the sealing strip 2 and the sealing strip contact area 3 are strips of an adhesive material.

Application of pressure to the outer surface of the folded pad, along the length of the sealing strip, causes the sealing strip to adhere to the sealing strip contact area, thereby forming a pouch having an interior volume 6 which contains and isolates the waste. In the embodiment shown, the collection area is covered with an absorbent layer 5.

The absorbent layer 5 may, in certain embodiments, be covered by a permeable topsheet (not shown.) The various components of the pad may be held together by means well-known in the art, including but not limited to thermal bonding and the use of hot-melt adhesives.

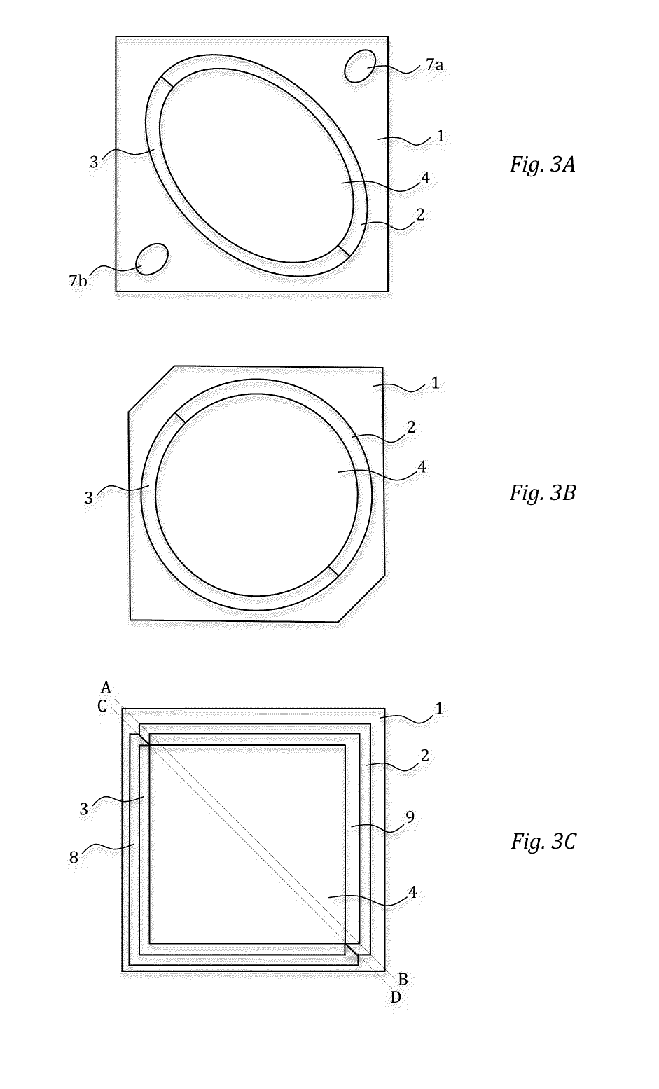

FIGS. 3A-3C show exemplary alternatives to the square pad and collection area shown in FIG. 1. In FIG. 3A, the collection area 4 is substantially oval in shape, and the ovals 7 and 7a represent finger holes cut out of the backing layer. When the pad is folded and sealed, the finger holes 7a and 7b are brought into register and together serve as a handle for cleanly carrying the folded pad and the waste contained within. FIG. 3B shows a square pad with a substantially circular collection area, and with opposite corners cut back so as to provide a more compact shape for the folded pad.

FIG. 3C shows an arrangement of the components that allows for a pad comprising mutually adhesive sealing strip 2 and sealing strip contact area 3 to be folded for packaging, transportation, and storage prior to use, without strips 2 and 3 coming into contact. When the pad shown in FIG. 3C is folded along the line C-D, the adhesive strips are out of register and do not contact one another. When folded in this manner, adhesive sealing strip 2 is brought into contact with a first non-adherent area 8, and sealing strip contact area 3 (also an adhesive layer) is brought into contact with a second non-adherent area 9. The non-adherent areas may simply comprise the exposed surface of the backing layer, provided that the adhesive strips do not bond so tightly to the backing layer as to prevent convenient unfolding of new, unused pads. In order to ease the unfolding, non-adherent areas may optionally be coated with a release layer, such as a silicone or fluorocarbon coating, to ensure that a folded pad can easily be pulled open prior to use. When being put to use to contain waste, the pad is folded over, substantially along diagonal A-B, to bring the adhesive strips into register and effect a seal.

Suitable materials for an absorbent layer, and methods for their manufacture, are well-known in the art, and any of the absorbent materials and permeable topsheet materials used, for example, in disposable diapers, sanitary napkins, panty liners, medical dressings and the like, may be employed in making the pads of the present invention. Examples include, but are not limited to, high- and low-loft non-woven polyester absorbent materials, hydrophilic polypropylene absorbents, fibrillated polyolefin pulp and cellulosic absorbents. The absorbent layer may optionally incorporate super-absorbent materials, such as for example sodium polyacrylate particles or fibers. Suitable materials, and methods for their use, are disclosed in U.S. Pat. No. 4,573,988, the entire contents of which are incorporated herein by reference, and in the references cited therein.

In certain embodiments, the topsheet, absorbent layer, and/or backing layer are manufactured from biodegradeable materials. They may, for example, be manufactured from a polymer, a copolymer, or a blend of polymers derived from lactic acid, poly(β-hydroxybutyrate-co-valerate), poly(butylene succinate) and/or polycaprolactone. Film layers may be manufactured from a polymer of the BAPE (biodegradable aliphatic polyester) type. Suitable materials, and methods for their use, are disclosed in U.S. Pat. Nos. 5,783,504, 6,201,068, 6,890,989 and 7,994,078, the entire contents of each of which are incorporated herein by reference, and in the references cited therein.

In preferred embodiments, the pad also comprises a drawstring or draw tape movably embedded in the periphery of the pad, for example by being loosely threaded back and forth through the pad, by being enclosed within a peripheral hem, or by being held in place at the periphery with loosely-fitting coverings or tabs, so as to permit a drawing action when the drawstring or draw tape is pulled. The draw tape or drawstring is provided with one or more exposed sections so situated that the user can gather the pad into a pouch, and secure it by tying off the exposed drawstring or draw tape. The drawn-out string or tape then serves as a convenient handle for carrying the pad and the enclosed waste. Methods of incorporating drawstrings and draw tapes into plastic film items are known in the art, for example in the manufacture of disposable trash bags. See for example U.S. Pat. No. 6,402,377 (2002), which is incorporated herein by reference in its entirety, and the references therein.

The pad of the present invention may optionally feature holes large enough to serve as handles, situated on opposite corners of the pad and located outside of the collection area and sealing strips. When the pad is folded and the sealing strips are engaged, the two holes are brought into register, and the user may carry the folded pad by passing one or more fingers through one or both holes.

A pad of the present invention is used by placing it beneath an animal about to defecate, or by placing waste to be disposed of on the collection area within the confines of the sealing strip and sealing strip contact area. Once the waste is deposited, the pad is folded over substantially along the axis separating the sealing strip and the sealing strip contact area, so as to cover the waste and bring the sealing strip and the sealing strip contact area into register. Appropriate pressure is applied to the sealing strip, so as to form a seal, thereby enclosing the waste within a sealed pouch. If the optional drawstring is present, it may then be used to draw the perimeter of the pad closed. The waste is thus effectively sealed and contained, and the pad may be carried to the nearest trash receptacle for disposal.

I claim:

1. A waste collection pad comprising a non-permeable sheet having an upper surface, a sealing strip disposed on the upper surface, and a sealing strip contact area disposed on the upper surface, wherein the sealing strip and the sealing strip contact area are mutually adherent and define a perimeter of a waste collection area, and wherein the sealing strip defines at least one half of the perimeter.

2. A waste collection pad according to claim 1, further comprising an absorbent layer disposed on the non-permeable sheet and interposed between the non-permeable layer and the sealing strip.

3. The waste collection pad according to claim 2, further comprising a permeable layer disposed on the absorbent layer and interposed between the absorbent layer and the sealing strip.

4. The waste collection pad according to claim 2, wherein the sealing strip comprises a hook portion of a hook-and-loop fastener system, and wherein the absorbent layer is capable of serving as the loop portion of a hook-and-loop fabric fastener system.

5. The waste collection pad according to claim 3, wherein the sealing strip comprises a hook portion of a hook-and-loop fastener system, and wherein the permeable layer is capable of serving as the loop portion of a hook-and-loop fabric fastener system.

6. The waste collection pad according to claim 1, wherein the sealing strip and the sealing strip contact area both comprise an adhesive layer.

7. The waste collection pad according to claim 2, further comprising a drawstring disposed around the perimeter of the non-permeable sheet.

8. The waste collection pad according to claim 3, further comprising a drawstring disposed around the perimeter of the non-permeable sheet.

9. The waste collection pad according to claim 4, further comprising a drawstring disposed around the perimeter of the non-permeable sheet.

10. The waste collection pad according to claim 5, further comprising a drawstring disposed around the perimeter of the non-permeable sheet.

11. The waste collection pad according to claim 6, further comprising a drawstring disposed around the perimeter of the non-permeable sheet.

12. The waste collection pad according to claim 7, further comprising a drawstring disposed around the perimeter of the non-permeable sheet.

13. A waste collection pad comprising a non-permeable sheet having an upper surface, and having an adhesive sealing strip disposed on the upper surface, wherein the sealing strip defines a perimeter of a waste collection area, said waste collection area being between 25% and 90% of the area of the pad.

14. The waste collection pad according to claim 13, further comprising an absorbent layer disposed on the upper surface thereof and substantially covering the waste collection area.

15. The waste collection pad according to claim 13, wherein the waste collection area is between 50% and 90% of the area of the pad.

16. The waste collection pad according to claim 15, further comprising an absorbent layer disposed on the upper surface thereof and substantially covering the waste collection area.
